(19) United States
(12) Patent Application Publication
(10) Pub. No.: US 2012/0026634 A1
(43) Pub. Date: Feb. 2, 2012

(54) VOLTAGE DETECTION CIRCUIT DEVICE

(76) Inventor: Ta-I LIU, Taipei City (TW)

(21) Appl. No.: 12/844,628

(22) Filed: Jul. 27, 2010

(51) Int. Cl. H02H 3/00

(52) U.S. Cl. 361/86

(57) ABSTRACT

A voltage detection circuit device acquires a predetermined compare voltage through a voltage acquisition circuit by a power source of a power supply circuit. After a voltage step-down circuit steps down a voltage, the compare voltage acts as a voltage reference, and high and low potential comparators of the compare circuit compare the voltage of a power source of the power supply circuit. If the voltage of the power source of the power supply circuit falls within a normal range, the high potential comparator will output a high potential signal, while the low potential comparator will output a low potential signal. After an electronic circuit supplied with electric power receives the electric potential signals, the electronic circuit starts its operation. By determining whether or not the voltage of the power supply falls within the normal range, damages to the electronic circuit by abnormal power supply can be prevented.

### BACKGROUND OF THE INVENTION

1. Field of the invention

The present invention relates to a voltage detection circuit device, more particularly to a circuit device that compares a voltage of a power source of a power supply circuit and determines whether or not the voltage falls within a normal range, so as to prevent an electronic circuit from being damaged by an abnormal power supply.

2. Description of Related Art

In general, when a power supply starts outputting an operating voltage, the electric potential of the operating voltage not necessarily reaches a normal electric potential at the beginning, and the operating voltage must go through a delay time before it reaches the normal electric potential. During the period for the operating voltage to rise to the critical electric potential, the power supply can enable an electric potential confirm signal to inform an external system to be turned on.

If the operating voltage rises and reaches the critical potential, the electric potential confirm signal will start pulling, such that the electric potential confirm signal will be enabled to a high potential after it has gone through the rising time. Ideally, the electric potential confirm signal has a smooth rising edge in the rising time. However, the rising time is usually very long, so that a jitter of the rising edge of the electric potential confirm signal may occur easily due to noises, and a misjudgment may be made by an external system easily.

Obviously, the foregoing prior art has drawbacks and requires improvements.

### SUMMARY OF THE INVENTION

In view of the aforementioned shortcomings of the conventional power supply, the inventor of the present invention based on years of experience in the related industry to conduct extensive researches and experiments, and finally developed a voltage detection circuit device in accordance with the present invention to overcome the shortcomings of the prior art.

Therefore, it is a primary objective of the present invention to provide a voltage detection circuit device capable of detecting an electric potential of a power supply circuit automatically, such that an electric power is supplied when the electric potential reaches a normal range.

To achieve the foregoing objective, the present invention provides a voltage detection circuit device comprising a power supply circuit, and the power supply circuit comprises a voltage acquisition circuit, a voltage step-down circuit and a compare circuit, wherein the voltage acquisition circuit is comprised of a plurality of resistors with different resistance and a plurality of fuses connected in parallel with each other, and a portion of blown fuses can step down a power source of the power supply circuit via a predetermined number of resistors to acquire a predetermined compare voltage; the voltage step-down circuit is electrically coupled to the voltage acquisition circuit and composed by connecting two resistors to a fuse in parallel to each other, such that the fuse can be blown/not blown to step down the compare voltage by one of the resistors; the compare circuit is electrically coupled to the voltage step-down circuit and includes a high potential comparator and a low potential comparator, wherein the high potential comparator can compare the compare voltage with the voltage of a power source of the power supply circuit, such that if the voltage of the power source of the power supply circuit falls within a normal range, then a high potential signal will be outputted. The low potential comparator can compare the compare voltage with the voltage of a power source of the power supply circuit, such that if the voltage of the power source of the power supply circuit falls within the normal range, then a low potential signal will be outputted. When use, the power source of the power supply circuit acquires the predetermined compare voltage by the voltage acquisition circuit. After the voltage is stepped down by the voltage step-down circuit, the compare voltage will act as a voltage reference, and a high potential comparator and a low potential comparator of the compare circuit compare the voltage of the power supply of the power supply circuit. If the voltage of the power supply of the power supply circuit falls within a normal range, the high potential comparator will output a high potential signal, while the low potential comparator will output a low potential signal, such that after an electronic circuit supplied with electric power receives the electric potential signals, the electronic circuit will start its operation by using the power source of the power supply circuit. By comparing and determining whether or not the power source of the power supply circuit falls within the normal range, damages to the electronic circuit by abnormal power supply can be prevented.

The technical contents and effects of the present invention will become apparent with the detailed description of a preferred embodiment of the present invention together the illustration of a related drawing as follows.

### BRIEF DESCRIPTION OF THE DRAWINGS

FIG. 1 is a schematic circuit diagram of the present invention.

### DETAILED DESCRIPTION OF THE INVENTION

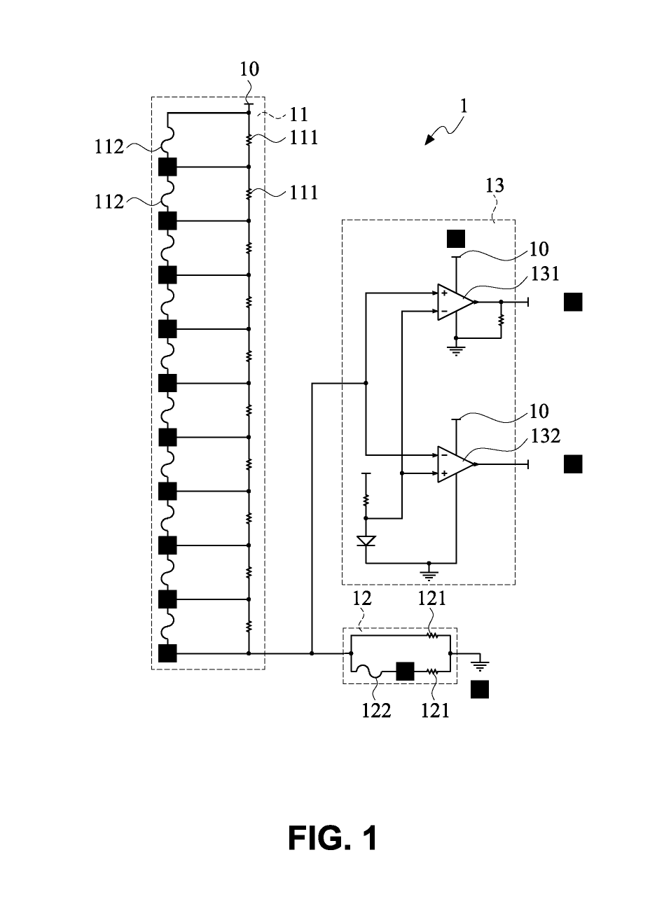

With reference to FIG. 1 for a voltage detection circuit device of the present invention, the voltage detection circuit device comprises a power supply circuit 1 including a voltage acquisition circuit 11, a voltage step-down circuit 12 and a compare circuit 13.

The voltage acquisition circuit 11 comprises a plurality of resistors with different resistance 111 and a plurality of fuses 112 connected in parallel, and a portion of blown fuses 112 can step down the voltage of a power source 10 of the power supply circuit 1 through a predetermined number of resistors 111 to acquire a predetermined compare voltage.

The voltage step-down circuit 12 is electrically coupled to the voltage acquisition circuit 11, and formed by connecting two resistors 121 and a fuse 122 in parallel, such that the fuse 122 can be blown/not blown to step down the compare voltage by one of the resistors 121.

The compare circuit 13 is electrically coupled to the voltage step-down circuit 12 and includes a high potential comparator 131 and a low potential comparator 132, wherein the high potential comparator 131 can compare the compare voltage with the voltage of the power source 10 of the power supply circuit 1. If the power source 10 of the power supply circuit 1 falls within a normal range, a high potential signal will be outputted; and the low potential comparator 132 can compare the compare voltage with the voltage of the power source 10 of the power supply circuit 1. If the power source 10 of the power supply circuit 1 falls within the normal range, a low potential signal will be outputted.

With the assembly of the foregoing components, the power supply 10 of the power supply circuit 1 acquires the predetermined compare voltage through the voltage acquisition circuit 11. After the voltage step-down circuit 12 steps down the voltage, the compare voltage will act as a voltage reference, and the high potential comparator 131 and the low potential comparator 132 of the compare circuit 13 compare the power source 10 of the power supply circuit 1, such that if the voltage of the power source 10 of the power supply circuit 1 falls within the normal range, the high potential comparator 131 will output a high potential signal, while the low potential comparator 132 will output a low potential signal, such that after an electronic circuit (not shown in the figure) supplied with an electric power receives the electric potentials, the electronic circuit starts its operation by using the power source 10 of the power supply circuit 1. By comparing and determining whether or not the voltage of the power source 10 of the power supply circuit 1 falls within the normal range, damages to an electronic circuit supplied with an abnormal power supply can be prevented.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A voltage detection circuit device, comprising:
a power supply circuit, including:
a voltage acquisition circuit, formed by connecting a plurality of resistors having different resistances with a plurality of fuses in parallel, and provided for using a portion of blown fuses to step down a power source of the power supply circuit by a predetermined number of resistors to acquire a predetermined compare voltage;
a voltage step-down circuit, electrically coupled to the voltage acquisition circuit, and formed by connecting two resistors and a fuse in parallel, such that the fuse can be blown/not blown to step down the compare voltage by one of the resistors;
a compare circuit, electrically coupled to the voltage step-down circuit, and including a high potential comparator and a low potential comparator, wherein the high potential comparator is provided for comparing the compare voltage with the voltage of the power source of the power supply circuit, such that if the voltage of the power source of the power supply circuit falls within a normal range, a high potential signal will be outputted, and the low potential comparator is provided for comparing the compare voltage with the voltage of the power source of the power supply circuit, such that if the voltage of the power source of the power supply circuit falls within the normal range, a low potential signal will be outputted, so that after an electronic circuit supplied with the power source receives the electric potential signals, the electronic circuit starts using the power source of the power supply circuit for an operation of the electronic circuit.
